(19) United States
(12) Patent Application Publication
(10) Pub. No.: US 2026/0003450 A1
(43) Pub. Date: Jan. 1, 2026

(54) INFORMATION INPUT

(71) Applicant: Beijing Zitiao Network Technology Co., Ltd, Beijing (CN)

(72) Inventor: Tong XING, Beijing (CN)

(21) Appl. No.: 19/253,702

(22) Filed: Jun. 27, 2025

Related U.S. Application Data
(63) Continuation of application No. PCT/CN2024/102741, filed on Jun. 28, 2024.

(51) Int. Cl. G06F 3/038; G06F 3/0481; G06F 3/0484

(52) U.S. Cl. CPC G06F 3/038; G06F 3/0481; G06F 3/0484

(57) ABSTRACT

Embodiments of the disclosure relate to information input. In a method, an information input component is presented in a display device, and the information input component includes a plurality of input positions for inputting different portions of information. In response to a first input position of the plurality of input positions being in an input state, a first set of elements matching the first input position is determined from a plurality of elements associated with an input panel. The first set of elements in a first style is presented in the input panel to indicate that the first set of elements are in a selectable state. An indicator is moved between the first set of elements displayed by the input panel. In response to receiving an input instruction via the controller, a second element corresponding to the indicator is inputted to the first input position.

### CROSS-REFERENCE

This application is a continuation of International Patent Application No. PCT/CN2024/102741 filed on Jun. 28, 2024, entitled “METHOD, APPARATUS, DEVICE AND STORAGE MEDIUM FOR INFORMATION INPUT”, which is hereby incorporated by reference in its entirety.

### FIELD

Example embodiments of the present disclosure generally relate to the computer field, and more particularly, to information input.

### BACKGROUND

In recent years, with the development of technologies, large-screen electronic devices such as televisions also support the installation of a wide variety of applications. Unlike input processes of mobile terminals, users often need to use additional controllers (e.g., remote control devices) during the input to large screen electronic devices. How to improve the efficiency of information input to large-screen electronic devices is the focus of attention to people.

### SUMMARY

In a first aspect of the present disclosure, a method of information input is provided. The method comprises: presenting an information input component in a display device, the information input component comprising a plurality of input positions for inputting different portions of information; in response to a first input position of the plurality of input positions being in an input state, determining a first set of elements matching the first input position from a plurality of elements associated with an input panel based at least on a first element which has been input at a second input position of the plurality of input positions; presenting the first set of elements in a first style in the input panel to indicate that the first set of elements are in a selectable state; moving an indicator between the first set of elements displayed by the input panel based on a movement instruction received via a controller associated with the display device; and in response to receiving an input instruction via the controller, inputting a second element corresponding to the indicator to the first input position.

In a second aspect of the present disclosure, an apparatus for information input is provided. The apparatus comprises: a component presenting module configured to present an information input component in a display device, the information input component comprising a plurality of input positions for inputting different portions of information; an element determining module configured to, in response to a first input position of the plurality of input positions being in an input state, determine a first set of elements matching the first input position from a plurality of elements associated with an input panel based at least on a first element which has been input at a second input position of the plurality of input positions; an element presenting module configured to present the first set of elements in a first style in the input panel to indicate that the first set of elements are in a selectable state; an element switching module configured to move an indicator between the first set of elements displayed by the input panel based on a movement instruction received via a controller associated with the display device; and an element input module configured to, in response to receiving an input instruction via the controller, input a second element corresponding to the indicator to the first input position.

In a third aspect of the present disclosure, a display device is provided. The device comprises: at least one processing unit; and at least one memory coupled to the at least one processing unit and storing instructions executable by the at least one processing unit, the instructions, when executed by the at least one processing unit, causing the display device to perform the method according to the first aspect of the present disclosure.

In a fourth aspect of the present disclosure, a computer readable storage medium is provided. The computer readable storage medium has a computer program stored thereon, wherein the computer program is executable by a processor to implement the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective embodiments of the present disclosure will become more apparent from the following detailed description with reference to the accompanying drawings. The same or similar reference numerals represent the same or similar elements throughout the figures, where:

FIG. 1 illustrates a schematic diagram of an example environment in which embodiments of the present disclosure may be implemented;

FIGS. 2A-2D illustrate example interfaces according to some embodiments of the present disclosure;

FIG. 3 shows a flowchart of an example process of information input according to some embodiments of the present disclosure;

FIG. 4 illustrates a schematic structural block diagram of an example apparatus for information input according to some embodiments of the present disclosure; and

FIG. 5 illustrates a block diagram of a device capable of implementing various embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure may be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be noted that the headings of any sections/subsections provided herein are not limiting. Various embodiments are described throughout this specification, and any type of embodiment may be included under any section/subsection. Furthermore, embodiments described in any section/subsection may be combined in any manner with any other embodiments described in the same section/subsection and/or different sections/subsections.

As used herein, the term “comprise” and its variants are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below. The terms “first”, “second” and the like may refer to different or identical objects. Other explicit and implicit definitions may also be included below.

The embodiments of the present disclosure may involve user data, the acquisition and/or use of data, etc. These aspects shall comply with corresponding laws and regulations and relevant provisions. In the embodiments of this disclosure, all the collection, acquisition, treatment, processing, forwarding and use of data are performed with the user's knowledge and confirmation. Accordingly, when implementing respective embodiments of the present disclosure, the user should be informed of the type, scope of use, and use scenario of the data or information involved in the present disclosure in an appropriate manner in accordance with relevant laws and regulations, and user authorization should be obtained. The specific notification and/or authorization methods may vary according to the actual situation and application scenarios, and the scope of the present disclosure is not limited in this regard.

In the solutions in this specification and embodiments, the processing of personal information, if involved, will be processed on the premise of legal basis (such as obtaining the consent of the personal information subject, or necessary to fulfill the contract, etc.), and will only be processed within the specified or agreed scope. The user's refusal to process personal information other than the necessary information required for basic functions will not affect the user's use of basic functions.

As briefly mentioned above, according to conventional interaction solutions, information input by a user to an application installed in a television mainly relies on a remote control device. When the user performs information input to an application installed in a television by using a remote control device, frequent complex operations need to be performed through the remote controller, so that the efficiency of information input is low.

The embodiments of the present disclosure provide a solution for information input. According to this solution, an information input component may be presented in a display device, the information input component comprising a plurality of input positions for inputting different portions of information. Further, in response to a first input position of the plurality of input positions being in an input state, a first set of elements matching the first input position may be determined from a plurality of elements associated with an input panel based at least on a first element which has been input at a second input position of the plurality of input positions.

Further, the first set of elements may be presented in a first style in the input panel to indicate that the first set of elements are in a selectable state. Further, an indicator may be moved between the first set of elements displayed by the input panel based on a movement instruction received via a controller associated with the display device. Accordingly, a second element corresponding to the indicator may be input to the first input position in response to receiving an input instruction via the controller.

In this way, according to the embodiments of the present disclosure, the movement instruction received by the display device may move between elements in a predetermined set of elements when the user performs information input to the display device through the controller. Therefore, the embodiments of the present disclosure may reduce the number of selectable elements in the information input process and improve the efficiency of information input.

Various example implementations of the solution will be further described in detail below with reference to the accompanying drawings.

### Example Environment

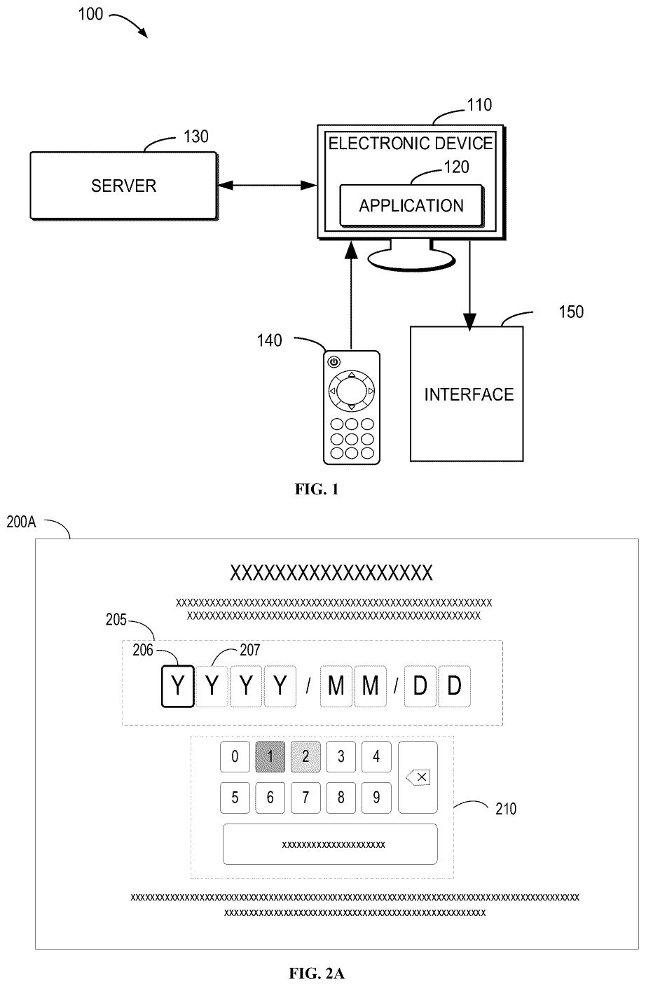

FIG. 1 shows a schematic diagram of an example environment 100 in which embodiments of the present disclosure may be implemented. As shown in FIG. 1, the example environment 100 may include a display device 110.

In this example environment 100, the electronic device 110 may run an application 120 that supports information input. The application 120 may be any suitable type of application requiring information input, examples of which may include but are not limited to: video applications, social networking applications, or other appropriate applications. A user may interact with the application 120 via a controller 140 communicatively connected with the display device 110.

In the environment 100 of FIG. 1, if the application 120 is active, the display device 110 may present an interface 150 for supporting information input through the application 120.

In some embodiments, the electronic device 110 communicates with a server 130 to enable the provision of services to the application 120. The electronic device 110 may be any type of device to be controlled by a controller, such as a television, a projector, or the like. The electronic device 110 may include, for example, a display device, and the display device may include an image generating component and an optical display component, configured to generate a corresponding image on a screen or a curtain of the display device.

The server 130 may be an independent physical server, or a server cluster or distributed system composed of multiple physical servers, or may further be a cloud server providing basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the application 120 which supports virtual scenarios in the display device 110.

A communication connection may be established between the server 130 and the display device 110. Communication connections may be established in a wired or wireless manner. Communication connections may include but are not limited to Bluetooth connections, mobile network connections, universal serial bus (USB) connections, Wireless Fidelity (WiFi) connections, etc. The embodiments of the present disclosure are not limited in this regard. In the embodiments of the present disclosure, the server 130 and the display device 110 may implement signaling interaction through the communication connection between them.

It should be understood that the structure and function of various elements in the environment 100 are described for illustrative purposes only and do not imply any limitation on the scope of the present disclosure.

Some example embodiments of the present disclosure will be described below with reference to the accompanying drawings.

### Example Interaction

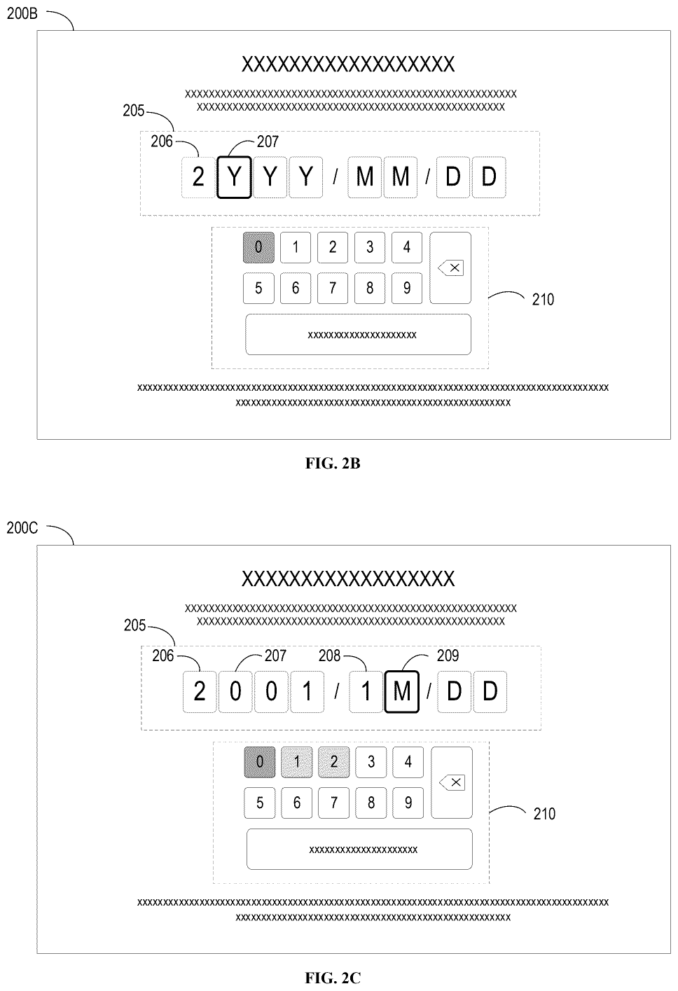

FIGS. 2A to 2C illustrate example interfaces 200A to 200C according to some embodiments of the present disclosure. The interfaces 200A and 200B may be provided, for example, by the electronic device 110 shown in FIG. 1. Examples 200A, 200B, and 200C are described below with reference to FIG. 1.

The electronic device 110 may construct the information input interface 200A as presented in FIG. 2A on a display device.

The information interface 200A in the electronic device 110 comprises an information input component 205 for inputting information, the information input component comprising a plurality of input positions for inputting different portions of information.

As an example, as shown in FIG. 2A, the information input component 205 in the information interface 200A comprises a date input component, and the plurality of input positions are used for inputting different numbers in a date.

Specifically, the information input component 205 comprises four input positions for inputting a year, two input positions for inputting a month, and two input positions for inputting a date within a corresponding month.

As an example, as shown in FIG. 2A, when the user inputs a date to a first input position 206 in the electronic device 110 through the controller 140, the electronic device 110 may limit an imputable element of the first input position 206 to 1 or 2 according to a current date. Further, the electronic device 110 may present elements 1 and 2 in an input panel 210 in a first style (e.g., highlighting, bolding, etc.) to indicate that the elements 1 and 2 are in a selectable state.

As another example, when information input is performed in year 3000, 3 is further allowed to be input and 1 is not allowed. Alternatively, the electronic device 110 may not limit the input element, for example, and present all elements in the input panel 210 in the first style.

When the elements 1 and 2 in the input panel 210 are presented in the first style, other elements will be presented in a second style to indicate that a second set of elements are in an unselectable state. As shown in FIG. 2A, elements 0, 3, 4, 5, 6, 7, 8, 9 in the input panel 210 are all presented in the second style.

When the electronic device 110 receives a rightward movement instruction sent by the user through the controller 140, a movement indicator will hover over the element 2 to represent that the element 2 is currently selected as an input element of the first input position 206. It is noteworthy that, when the electronic device 110 continues to receive rightward movement instructions from the controller 140, the indicator will be jumped to the element 1, to ensure that the movement indicator jumps between limited elements.

In this way, the embodiments of the present disclosure can limit the number of elements in the input panel 210 when the user performs information input to the electronic device 110. Accordingly, when the user inputs the movement instruction through the controller 140, only the elements in the predetermined set of elements can be selected. Therefore, the embodiments of the present disclosure can effectively reduce the complexity of user interaction operation on the electronic device, thereby improving the efficiency of information input.

As shown in FIG. 2A, when the electronic device 110 receives an input instruction, the element 2 is input to the input position 206, and an input position 207 may be further set to an input state.

In some embodiments, the electronic device 110 may determine one or more input positions associated with the input position 207. For example, the electronic device 110 may determine that the input position 206 is associated with the input position 207 based on an information correlation between different input positions. For example, the input position 206 is for inputting a first digit of the year, and the input position 207 is for inputting a second digit of the year.

Further, since the second digit of the year may depend on the first digit of the year, the electronic device 110 may determine that the input position 206 is associated with the input position 207.

In some examples, one input position may also be associated with other multiple input positions, for example. For example, for a third digit of the year, the digit may, for example, be associated with the first digit and the second digit of the year at the same time.

As shown in FIG. 2B, after the element is input in the first input position 206, the second input position 207 is set to an input state to prompt the user to input information in the second input position 207. For example, where ta current year is 2024 for example, as shown in FIG. 2B, the electronic device 110 may determine that the element matching the input position 207 includes only the digit “0” based on the fact that the first digit of the year has been input as “2”.

Accordingly, the electronic device 110 may display an element, e.g., digit “0”, which matches the input position 207 in the first style in the input panel 210. In some embodiments, the elements displayed in the first style may be in a selectable state.

In some embodiments, the electronic device 110 may also display other elements in the second style in the input panel 210 to indicate that such other elements are in a non-selectable state. Alternatively, the electronic device 110 may also hide these other elements, to reduce the user's interaction cost.

As another example, as shown in FIG. 2C, an input position 208 and an input position 209 may correspond to a first digit and a second digit of a month. After inputting the digit “1” to the input position 208, the input position 209 may be switched to an input state, for example.

As an example, the electronic device 110 may determine that the input position 209 is associated with the input position 208. Further, the electronic device 110 may determine, based on an element (e.g., digit “1”) which has been input in the input position 208, a plurality of elements that match the input position 209, i.e., digit “0.” digit “1,” and digit “2”.

Accordingly, as shown in FIG. 2C, the electronic device 110 may present, in the input panel, a plurality of elements in the input panel 210 that match the input position 209 in the first style, such as digit “0”, digit “1”, and digit “2”.

In some embodiments, the electronic device 110 may further receive a movement instruction input by the user via the controller 140 and may move an indicator (e.g., a cursor) between the digit “0”, the digit “1”, and the digit “2” in the input panel 210 accordingly.

For example, taking FIG. 2C as an example, the electronic device 110 may accordingly switch the position of the indicator among the selectable elements based on a received left movement instruction or right movement instruction. Such an indicator will not be displayed at other elements that are not selectable based on the received movement instruction, e.g., digit “3,” digit “4,” . . . , digit “9.”

In this way, the embodiments of the present disclosure may reduce the operation cost of the user for selecting a desired input element through a controller, thereby improving the efficiency of information input.

Further, as shown in FIG. 2D, after completing the input of the plurality of input positions, the electronic device 110 may set a confirmation button 211 to the selectable state. Further, the electronic device 110 may receive a trigger for the confirmation button 211, and may determine the target information to be input based on the input element in the plurality of input positions. Taking FIG. 2D as an example, such target information may be obtained by combining digits input at a plurality of input positions, for example, “2021 Dec. 21”.

In some embodiments, the electronic device 110 may further determine a constraint associated with the target information according to a preset condition. If the input target information does not satisfy the preset condition, the electronic device 110 may also display a reminder message, for example.

In some embodiments, taking the date information as an example of the target information, such a constraint may comprise, for example, that an input date needs to be earlier or later than a preset date. When the input date does not satisfy the constraint, the electronic device 110 may display the corresponding reminder message.

In some embodiments, with reference to FIGS. 2A-2D, the input panel 210 in the electronic device 110 may display a plurality of input elements according to a target layout. Such a target layout may result in any of the plurality of selectable elements in the target panel 210 having a first adjacent element in the horizontal direction or a second adjacent element in the vertical direction.

Taking FIG. 2C as an example, the plurality of selectable elements includes digit “0”, digit “1”, and digit “2”. The three digits may be adjacently arranged in one horizontal row, so that the user can quickly select a digit to be input by moving left and right.

Considering that the controller (for example, the remote control device) usually only supports interaction in the horizontal direction and the vertical direction, such a layout may ensure that the selectable element does not have a dislocation condition, thereby improving the rationality and convenience of the interactive operation.

It should be understood that although the input process of the target information has been described above with reference to the date information, the information input process is also applicable to input of other suitable types of information, for example, the input of serial numbers having a preset construction rule.

Additionally, while the above example describes the information input process of the present disclosure in terms of sequential input of elements in a plurality of positions as an example, the embodiments of the present disclosure may also support situations in which the input is performed in any other sequence. Continuing with the date as an example, the user may first input the second digit of the month and then input the first digit of the month. In this case, the candidate digit matching the first digit of the month may be determined based on the second digit that has been input.

Based on the above process, the embodiments of the present disclosure may enable the indicator to move among the elements in the predetermined set of elements when the user inputs information to the electronic device through the controller. Therefore, the embodiments of the present disclosure may reduce the number of selectable elements in the information input process and improve the efficiency of information input.

### Example Process

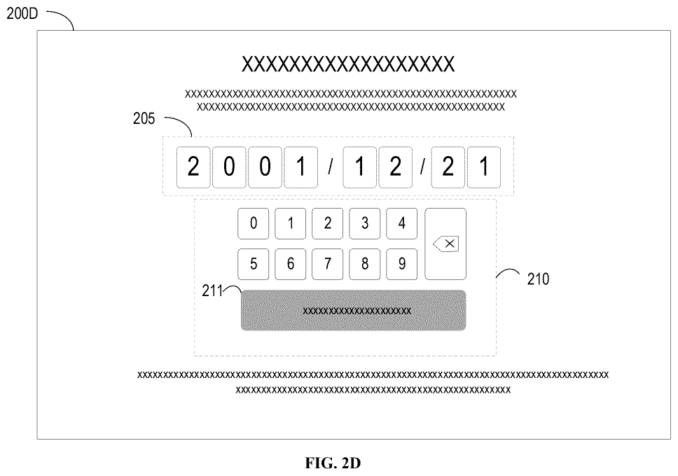

FIG. 3 illustrates a flowchart of an example process 300 of information input according to some embodiments of the present disclosure. The process 300 may be implemented at the electronic device 110. The process 300 is described below with reference to FIG. 1.

As depicted, at block 310, the electronic device 110 presents an information input component in a display device, the information input component comprising a plurality of input positions for inputting different portions of information.

At block 320, in response to a first input position of the plurality of input positions being in an input state, the electronic device 110 determines a first set of elements matching the first input position from a plurality of elements associated with an input panel based at least on a first element which has been input at a second input position of the plurality of input positions.

At block 330, the electronic device 110 presents the first set of elements in a first style in the input panel to indicate that the first set of elements are in a selectable state.

At block 340, the electronic device 110 moves an indicator between the first set of elements displayed by the input panel based on a movement instruction received via a controller associated with the display device.

At block 350, in response to receiving an input instruction via the controller, the electronic device 110 inputs a second element corresponding to the indicator to the first input position.

In some embodiments, the process 300 further comprises: presenting a second set of elements of the plurality of elements different from the first set of elements in a second style in the input panel to indicate that the second set of elements are in a non-selectable state.

In some embodiments, the input panel displays the plurality of elements according to a target layout, causing: in response to a number of the first set of input elements being greater than one, any of the first set of input elements to have a first adjacent element in a horizontal direction and/or a second adjacent element in a vertical direction, the first adjacent element and the second adjacent element being comprised in the first set of elements.

In some embodiments, the process 300 further comprises: determining the second input position associated with the first input position from the plurality of input positions.

In some embodiments, the first input position is configured to input a target portion of the information, and determining the second input position associated with the first input position from the plurality of input positions comprises: determining the second input position associated with the first input position from the plurality of input positions based on a correlation between the target portion and a further portion to be input at a further input position.

In some embodiments, the process 300 further comprises: determining target information based at least on the input first element and second element; and in response to the target information not satisfying a predetermined condition, presenting a prompt message in the display device.

In some embodiments, the information input component comprises a date input component, and the plurality of input positions are configured to input different digits in a date.

### Example Apparatus and Device

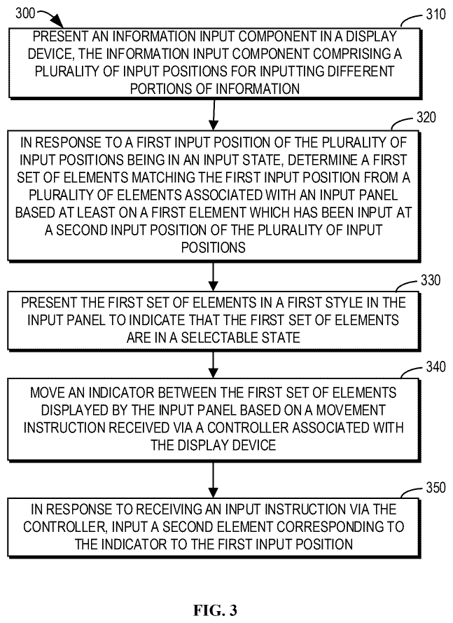

The embodiments of the present disclosure further provide a corresponding apparatus for implementing the above method or process. FIG. 4 illustrates a schematic structural block diagram of an exemplary apparatus 400 for information input according to certain embodiments of the present disclosure. The apparatus 400 may be implemented as or included in the electronic device 110. Respective modules/components in the apparatus 400 may be implemented by hardware, software, firmware, or any combination thereof.

As shown in FIG. 400, the apparatus 400 comprises: a component presenting module 410 configured to present an information input component in a display device, the information input component comprising a plurality of input positions for inputting different portions of information; an element determining module 420 configured to in response to a first input position of the plurality of input positions being in an input state, determine a first set of elements matching the first input position from a plurality of elements associated with an input panel based at least on a first element which has been input at a second input position of the plurality of input positions; an element presenting module 430 configured to present the first set of elements in a first style in the input panel to indicate that the first set of elements are in a selectable state; an element switching module 440 configured to move an indicator between the first set of elements displayed by the input panel based on a movement instruction received via a controller associated with the display device; and an element input module 450 configured to in response to receiving an input instruction via the controller, input a second element corresponding to the indicator to the first input position.

In some embodiments, the input panel displays the plurality of elements according to a target layout, causing: in response to a number of the first set of input elements being greater than one, any of the first set of input elements to have a first adjacent element in a horizontal direction and/or a second adjacent element in a vertical direction, the first adjacent element and the second adjacent element being comprised in the first set of elements.

In some embodiments, the element presenting module 430 is further configured to: present a second set of elements of the plurality of elements different from the first set of elements in a second style in the input panel to indicate that the second set of elements are in a non-selectable state.

In some embodiments, the element determining module 420 is further configured to: determine the second input position associated with the first input position from the plurality of input positions.

In some embodiments, the first input position is configured to input a target portion of the information, and the element determining module 420 is further configured to: determine the second input position associated with the first input position from the plurality of input positions based on a correlation between the target portion and a further portion to be input at a further input position.

In some embodiments, the apparatus 400 further comprises: a prompting module configured to determine target information based at least on the input first element and second element; and in response to the target information not satisfying a predetermined condition, presenting a prompt message in the display device.

In some embodiments, the information input component comprises a date input component, and the plurality of input positions are configured to input different digits in a date.

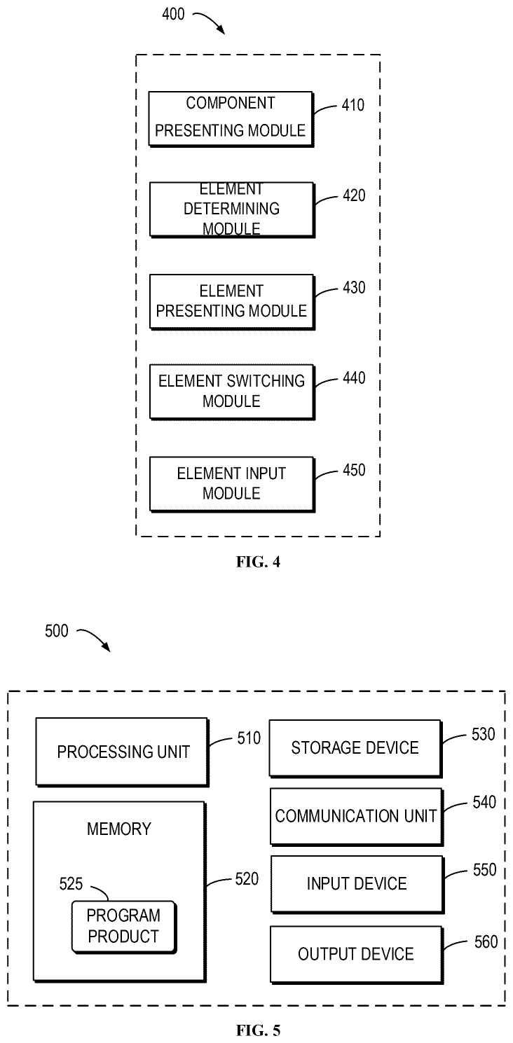

FIG. 5 shows a block diagram of a computing device 500 that may implement one or more embodiments of the present disclosure. It should be understood that the computing device 500 shown in FIG. 5 is merely exemplary and should not constitute any limitation on the functionality and scope of the embodiments described herein. The computing device 500 shown in FIG. 5 may be used to implement the electronic device 110 in FIG. 1.

As shown in FIG. 5, the computing device 500 is in the form of a general purpose computing device. Components of the computing device 500 may include, but are not limited to, one or more processors or processing units 510, a memory 520, a storage device 530, one or more communication units 540, one or more input devices 1550, and one or more output devices 560. The processing unit 510 may be a physical or virtual processor and may execute various processing based on the programs stored in the memory 520. In a multi-processor system, a plurality of processing units executes computer-executable instructions in parallel to enhance parallel processing capability of the computing device 500.

The computing device 500 usually includes a plurality of computer storage mediums. Such mediums may be any attainable medium accessible by the computing device 500, including but not limited to, a volatile and non-volatile medium, a removable and non-removable medium. The memory 520 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 530 may be a removable or non-removable medium, and may include a machine-readable medium (e.g., a memory, a flash drive, a magnetic disk) or any other medium, which may be used for storing information and/or data (e.g., training data for training) and be accessed within the computing device 500.

The computing device 500 may further include additional removable/non-removable, volatile/non-volatile storage mediums. Although not shown in FIG. 5, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 520 may include a computer program product 525 having one or more program modules, and these program modules are configured for performing various methods or acts of various embodiments of the present disclosure.

The communication unit 540 implements communication with another computing device via a communication medium. Additionally, functions of components of the computing device 500 may be realized by a single computing cluster or a plurality of computing machines, and these computing machines may communicate through communication connections. Therefore, the computing device 500 may operate in a networked environment using a logic connection to one or more other servers, a Personal Computer (PC) or a further general network node.

The input device 550 may be one or more various input devices, such as a mouse, a keyboard, a trackball, a voice-input device, and the like. The output device 560 may be one or more output devices, e.g., a display, a loudspeaker, a printer, and so on. The electronic device 500 may also communicate through the communication unit 540 with one or more external devices (not shown) as required, where the external device, e.g., a storage device, a display device, and so on, communicates with one or more devices that enable users to interact with the computing device 500, or with any device (such as a network card, a modem, and the like) that enable the computing device 500 to communicate with one or more other computing devices. Such communication may be executed via an Input/Output (I/O) interface (not shown).

According to the example implementations of the present disclosure, a computer-readable storage medium is provided, on which computer-executable instructions are stored, wherein the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

What is claimed is:

1. A method of information input, comprising:
presenting an information input component in a display device, the information input component comprising a plurality of input positions for inputting different portions of information;
in response to a first input position of the plurality of input positions being in an input state, determining a first set of elements matching the first input position from a plurality of elements associated with an input panel based at least on a first element which has been input at a second input position of the plurality of input positions;
presenting the first set of elements in a first style in the input panel to indicate that the first set of elements are in a selectable state;
moving an indicator between the first set of elements displayed by the input panel based on a movement instruction received via a controller associated with the display device; and
in response to receiving an input instruction via the controller, inputting a second element corresponding to the indicator to the first input position.

2. The method of claim 1, further comprising:
presenting a second set of elements of the plurality of elements different from the first set of elements in a second style in the input panel to indicate that the second set of elements are in a non-selectable state.

3. The method of claim 1, wherein the input panel displays the plurality of elements according to a target layout, causing:
in response to a number of the first set of input elements being greater than one, any of the first set of input elements to have a first adjacent element in a horizontal direction and/or a second adjacent element in a vertical direction, the first adjacent element and the second adjacent element being comprised in the first set of elements.

4. The method of claim 1, further comprising:
determining the second input position associated with the first input position from the plurality of input positions.

5. The method of claim 4, wherein the first input position is configured to input a target portion of the information, and determining the second input position associated with the first input position from the plurality of input positions comprises:
determining the second input position associated with the first input position from the plurality of input positions based on a correlation between the target portion and a further portion to be input at a further input position.

6. The method of claim 1, further comprising:
determining target information based at least on the input first element and second element; and
in response to the target information not satisfying a predetermined condition, presenting a prompt message in the display device.

7. The method of claim 1, wherein the information input component comprises a date input component, and the plurality of input positions are configured to input different digits in a date.

8. A display device, comprising:
at least one processing unit; and
at least one memory coupled to the at least one processing unit and storing instructions executable by the at least one processing unit, the instructions, when executed by the at least one processing unit, causing the display device to perform acts comprising:
presenting an information input component in a display device, the information input component comprising a plurality of input positions for inputting different portions of information;
in response to a first input position of the plurality of input positions being in an input state, determining a first set of elements matching the first input position from a plurality of elements associated with an input panel based at least on a first element which has been input at a second input position of the plurality of input positions;
presenting the first set of elements in a first style in the input panel to indicate that the first set of elements are in a selectable state;
moving an indicator between the first set of elements displayed by the input panel based on a movement instruction received via a controller associated with the display device; and
in response to receiving an input instruction via the controller, inputting a second element corresponding to the indicator to the first input position.

9. The display device of claim 8, wherein the acts further comprise:
presenting a second set of elements of the plurality of elements different from the first set of elements in a second style in the input panel to indicate that the second set of elements are in a non-selectable state.

10. The display device of claim 8, wherein the input panel displays the plurality of elements according to a target layout, causing:
in response to a number of the first set of input elements being greater than one, any of the first set of input elements to have a first adjacent element in a horizontal direction and/or a second adjacent element in a vertical direction, the first adjacent element and the second adjacent element being comprised in the first set of elements.

11. The display device of claim 8, wherein the acts further comprise:
determining the second input position associated with the first input position from the plurality of input positions.

12. The display device of claim 11, wherein the first input position is configured to input a target portion of the information, and determining the second input position associated with the first input position from the plurality of input positions comprises:
determining the second input position associated with the first input position from the plurality of input positions based on a correlation between the target portion and a further portion to be input at a further input position.

13. The display device of claim 8, wherein the acts further comprise:
determining target information based at least on the input first element and second element; and
in response to the target information not satisfying a predetermined condition, presenting a prompt message in the display device.

14. The display device of claim 8, wherein the information input component comprises a date input component, and the plurality of input positions are configured to input different digits in a date.

15. A non-transitory computer readable storage medium having a computer program stored thereon, wherein the computer program is executable by a processor to implement acts comprising:
presenting an information input component in a display device, the information input component comprising a plurality of input positions for inputting different portions of information;
in response to a first input position of the plurality of input positions being in an input state, determining a first set of elements matching the first input position from a plurality of elements associated with an input panel based at least on a first element which has been input at a second input position of the plurality of input positions;
presenting the first set of elements in a first style in the input panel to indicate that the first set of elements are in a selectable state;
moving an indicator between the first set of elements displayed by the input panel based on a movement instruction received via a controller associated with the display device; and
in response to receiving an input instruction via the controller, inputting a second element corresponding to the indicator to the first input position.

16. The non-transitory computer readable storage medium of claim 15, wherein the acts further comprise:
presenting a second set of elements of the plurality of elements different from the first set of elements in a second style in the input panel to indicate that the second set of elements are in a non-selectable state.

17. The non-transitory computer readable storage medium of claim 15, wherein the input panel displays the plurality of elements according to a target layout, causing:
in response to a number of the first set of input elements being greater than one, any of the first set of input elements to have a first adjacent element in a horizontal direction and/or a second adjacent element in a vertical direction, the first adjacent element and the second adjacent element being comprised in the first set of elements.

18. The non-transitory computer readable storage medium of claim 15, wherein the acts further comprise:
determining the second input position associated with the first input position from the plurality of input positions.

19. The non-transitory computer readable storage medium of claim 18, wherein the first input position is configured to input a target portion of the information, and determining the second input position associated with the first input position from the plurality of input positions comprises:
determining the second input position associated with the first input position from the plurality of input positions based on a correlation between the target portion and a further portion to be input at a further input position.

20. The non-transitory computer readable storage medium of claim 15, wherein the acts further comprise:
determining target information based at least on the input first element and second element; and
in response to the target information not satisfying a predetermined condition, presenting a prompt message in the display device.
